(19) United States
(12) Patent Application Publication
(10) Pub. No.: US 2025/0355288 A1
(43) Pub. Date: Nov. 20, 2025

(54) OPTICAL DEVICES HAVING IMPROVED MODE TRANSITIONS

(71) Applicant: HyperLight Corporation, Cambridge, MA (US)

(72) Inventors: Andrew John Mercante, Newark, DE (US); Miles Matthew Kovach, Cambridge, MA (US); Christian Reimer, Wellesley, MA (US)

(21) Appl. No.: 19/209,416

(22) Filed: May 15, 2025

Related U.S. Application Data
(60) Provisional application No. 63/648,516, filed on May 16, 2024.

(51) Int. Cl. G02F 1/035

(52) U.S. Cl. CPC G02F 1/035; G02F 2202/20

(57) ABSTRACT

A photonics device including a waveguide and an index smoothing structure is described. The waveguide is configured to carry an optical signal and includes a thin film lithium-containing electro-optic (TFLCEO) material. The waveguide has a first portion, a transition portion, and a second portion. The optical signal has a first mode in the first portion and a second mode in the second portion. The transition portion transfers the optical signal between the first portion and the second portion and transitions between the first mode and the second mode. The index smoothing structure corresponds to the transition portion. The index smoothing structure is configured to transition a first effective index of refraction for the first mode to a second effective index of refraction for the second mode. The index smoothing structure having an intermediate effective index of refraction.

### CROSS REFERENCE TO OTHER APPLICATIONS

This application claims priority to U.S. Provisional Patent Application No. 63/648,516 entitled OPTICAL DEVICES HAVING IMPROVED MODE TRANSITIONS filed May 16, 2024 which is incorporated herein by reference for all purposes.

### BACKGROUND OF THE INVENTION

Photonics devices utilize optical signals propagating through waveguides to carry data. The configuration of the waveguide and surrounding structures may be used to perform various functions on the optical signal. For example, the mode may be converted over a region of the waveguide. A mode conversion typically involves a change in the geometry of the waveguide. The mode conversion results in a change in properties of the mode, such as a change in area, a change in shape, and/or a change in polarization. Other processing of the optical signal may include encoding data into the optical signal via electro-optic or other modulation, rotating the polarization, splitting of the optical signal onto multiple waveguides, coupling of multiple optical signals into fewer waveguides. and/or other manipulation of the optical signal.

Although optical signals may be transmitted and processed, photonics devices may be subject to losses. Various processes including but not limited to modulation of the optical signal may result in optical and/or other losses. For example, mode conversions may result in undesirable losses in the optical signal. In general, optical and other losses (e.g., microwave losses), are desired to be mitigated in order to improve performance. Accordingly, what is desired are techniques for improving manipulation of optical signals in photonics devices.

### BRIEF DESCRIPTION OF THE DRAWINGS

Various embodiments of the invention are disclosed in the following detailed description and the accompanying drawings.

FIG. 1 is a block diagram of an embodiment of a portion of a photonics device having a mode transition.

FIGS. 2A-2C depicts an embodiment of a portion of a photonics device having a mode transition.

FIG. 3 depicts an embodiment of a portion of a photonics device having a mode transition.

FIG. 4 depicts an embodiment of a portion of a photonics device having a mode transition.

FIG. 5 depicts an embodiment of a portion of a photonics device having a mode transition.

FIG. 6 depicts an embodiment of a portion of a photonics device having a mode transition.

FIG. 7 depicts an embodiment of a portion of a photonics device having a mode transition.

FIG. 8 depicts an embodiment of a portion of a photonics device having a mode transition.

FIG. 9 depicts an embodiment of a portion of a photonics device having a mode transition.

FIGS. 10A-10E depict an embodiment of a portion of a photonics device having a mode transition.

FIGS. 11A-11E depict an embodiment of a portion of a photonics device having a mode transition.

FIG. 12 depicts an embodiment of a portion of a photonics device having a mode transition.

FIG. 13 depicts an embodiment of a portion of a photonics device having a mode transition.

FIGS. 14A-14E depict an embodiment of a portion of a photonics device having a mode transition.

FIG. 15 depicts an embodiment of a portion of a photonics device having a mode transition.

FIG. 16 depicts an embodiment of a portion of a photonics device having a mode transition.

FIG. 17 is a flow chart depicting an embodiment of a method for providing a portion of a photonics device having a mode transition.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various operations may be performed on an optical signal propagating through a waveguide of a photonics device. For example, mode conversion (e.g., from a first mode to a second mode) is often performed for the optical mode of the optical signal. Although termed a first mode (e.g. before conversion) and a second mode (e.g. after conversion), the first and second modes are generally for the same optical signal. However, the properties of the first and second optical modes differ before. For example, a mode conversion may result in the modes having different optical phase or group indices, different mode areas, different mode shapes, different polarizations, different mode orders (e.g. fundamental and higher order modes), different locations of confinement in the waveguide, and/or other changes to the properties of the mode. In order to perform a mode conversion, the physical properties of the waveguide are typically changed. For example, the waveguide may have a different height and/or a different shape for the first mode than for the second mode. In some cases, the mode conversion may involve a change in the materials used in the waveguide and/or other feature of the waveguide.

Although optical signals may be transmitted and processed, photonics devices may be subject to losses. For example, mode conversions may result in undesirable losses in the optical signal. In general, optical and other losses (e.g., microwave losses), are desired to be mitigated in order to improve performance. Accordingly, what is desired are techniques for improving manipulation of optical signals in photonics devices.

A photonics device including a waveguide and an index smoothing structure is described. The waveguide is configured to carry an optical signal and includes a thin film lithium-containing electro-optic (TFLCEO) material. For example, the waveguide may include thin film lithium niobate (TFLN) and/or thin film lithium tantalate (TFLT). The waveguide has a first portion, a transition portion, and a second portion. The optical signal has a first mode in the first portion and a second mode in the second portion. The transition portion transfers the optical signal between the first portion and the second portion and transitions between the first mode and the second mode. The index smoothing structure corresponds to the transition portion. The index smoothing structure is configured to transition a first effective index of refraction for the first mode to a second effective index of refraction for the second mode. The index smoothing structure having an intermediate effective index of refraction.

In some embodiments, the index smoothing structure includes at least one of sub-wavelength feature(s) and overlay structure(s). The sub-wavelength feature(s) each have a dimension less than a wavelength of the optical signal. In some embodiments, the dimension of the sub-wavelength feature(s) is not more than ¼ of the wavelength of the optical signal. In some embodiments, multiple sub-wavelength features are present. The sub-wavelength features have a pitch and size(s). The pitch may be constant or vary. The size(s) (e.g. the dimension(s)) of the sub-wavelength features may be constant or may vary. Further, the sub-wavelength features may but need not be aligned (e.g. need not be aligned along the direction of propagation of the optical signal).

In some embodiments, an optical material is adjacent to the waveguide. The optical material (e.g., cladding) has an index of refraction. In such embodiments, the overlay structure has an overlay index of refraction greater than the index of refraction. For example, the overlay structure may include at least one of silicon nitride, silicon, lithium niobate, silicon oxynitride, doped silicon, aluminum nitride, or titanium doped silicon dioxide. In some such embodiments, the overlay structure consists of such materials. The overlay structure may intersect a transition optical mode of the optical signal for the transition portion. In some embodiments, the overlay structure is not more than one micrometer from the waveguide. In some embodiments, the overlay structure shares an interface with the waveguide.

The index smoothing structure may be configured such that a transition portion optical mode has at least an eighty percent match with the first mode and with the second mode. In some such embodiments, the transition portion optical mode has at least a ninety percent match with the first mode and with the second mode. In some embodiments, the index smoothing structure is configured such that optical losses through the transition portion do not exceed 0.5 dB.

A photonics device is described. The photonics device includes a waveguide and an index smoothing structure. The waveguide is configured to carry an optical signal and includes a TFLCEO material, such as TFLN and/or TLFT. The waveguide has a first portion, a transition portion, and a second portion. The optical signal has a first mode in the first portion and a second mode in the second portion. The transition portion transfers the optical signal between the first portion and the second portion and transitions the first mode to the second mode. The index smoothing structure corresponds to the transition portion and is configured to transition a first effective index of refraction for the first mode to a second effective index of refraction for the second mode. The index smoothing structure has an intermediate effective index of refraction. The index smoothing structure includes at least one of sub-wavelength features and an overlay structure, each of the plurality of sub-wavelength feature having a dimension less than one-fourth of a wavelength of the optical signal, the plurality of sub-wavelength features extending a distance equal to at least three multiplied by the wavelength, the overlay structure having an overlay index of refraction greater than an index of refraction of an optical material adjacent to the waveguide.

A method is described. The method includes providing a waveguide. The waveguide is configured to carry an optical signal and includes a (TFLCEO) material. The waveguide has a first portion, a transition portion, and a second portion. The optical signal has a first mode in the first portion and a second mode in the second portion. The transition portion transfers the optical signal between the first portion and the second portion. The transition portion also transitions the first mode to the second mode. The method also includes providing an index smoothing structure corresponding to the transition portion. The index smoothing structure is configured to transition a first effective index of refraction for the first mode to a second effective index of refraction for the second mode. The index smoothing structure has an intermediate effective index of refraction. Providing the index smoothing structure may include providing at least one of sub-wavelength features and overlay structure(s). Each of the sub-wavelength features has a dimension less than a wavelength of the optical signal. The overlay structure(s) have an overlay index of refraction greater than an index of refraction of an optical material adjacent to the waveguide. In some embodiments, the dimension of the sub-wavelength structure(s) is not more than ¼ of the wavelength of the optical signal. In some embodiments, the overlay structure is configured such that a transition portion optical mode has at least an eighty or at least an eighty-five percent match with the first mode and with the second mode.

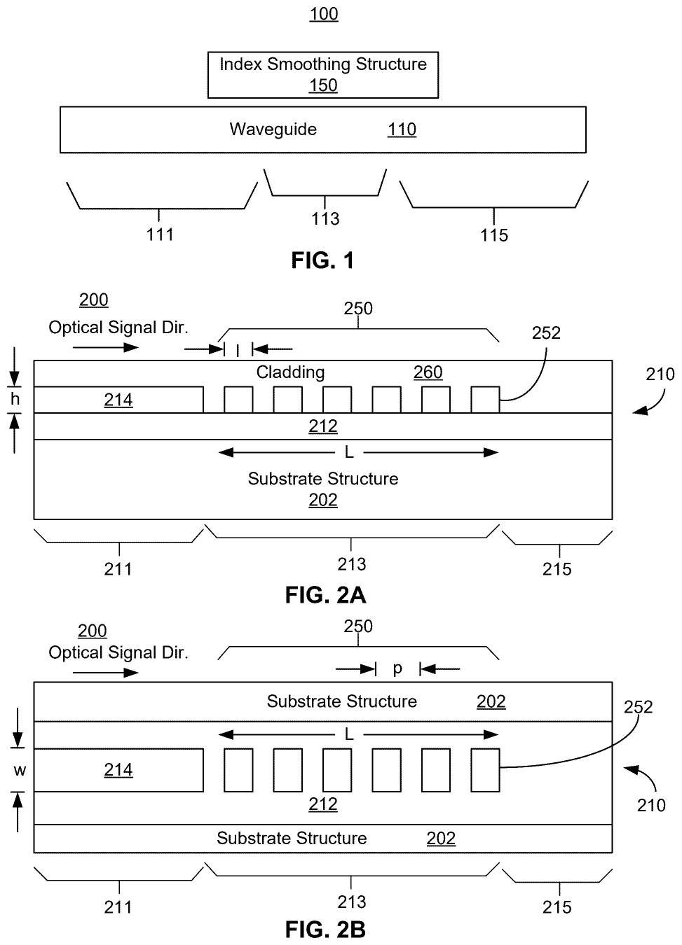

FIG. 1 is a block diagram of an embodiment of a portion of photonics device 100 having a mode transition. For clarity, only some components are depicted. Photonics device 100 includes waveguide 110 and index smoothing structure 150. Waveguide 110, as well as other portions of photonics device 100, include thin film lithium-containing electro-optic (TFLCEO) materials. For example, waveguide 110 may include thin film lithium niobate (TFLN) and/or thin film lithium tantalate (TFLT). In some embodiments, waveguide 110 may consist of TFLEO materials (e.g. TFLN and/or TFLT).

Although primarily described in the context of TFLCEO materials, such as TFLN and TFLT other nonlinear optical materials may be used in the optical devices described herein. For example, other ferroelectric nonlinear (e.g. second order) optical materials may also be desired to be used in waveguide 110. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used in waveguide 110 are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

Waveguide 110 is a thin film waveguide. For example, the thin film may have a thickness (e.g. of a slab portion and/or ridge portion) of not more than three multiplied by the optical wavelengths for the optical signal carried in waveguide 110 before processing. In some embodiments, the thin film has a thickness (e.g. of the slab portion and the ridge portion) of not more than two multiplied by the optical wavelengths. In some embodiments, the nonlinear optical material has a thickness of not more than one multiplied by the optical wavelength. In some embodiments, the nonlinear optical material has a thickness of not more than 0.5 multiplied by the optical wavelengths. For example, the ridge and/or slab portion may each have a thickness not exceeding 500 nanometers, not exceeding 300 hundred nanometers, not exceeding 250 hundred nanometers, not exceeding 200 hundred nanometers, or not exceeding 100 hundred nanometers. For example, the slab and ridge may have thicknesses of at least ten nanometers and not more than five hundred nanometers. The thin film may have a total thickness of not more than three micrometers as-formed. In some embodiment, the thin film has a total thickness of not more than two micrometers as-formed.

The TFLCEO material may be fabricated for photonics device 100 utilizing photolithography. For example, ultraviolet (UV) and/or deep ultraviolet (DUV) photolithography may be used to pattern masks for the nonlinear optical material. For DUV photolithography, the wavelength of light used is typically less than two hundred and fifty nanometers. To fabricate photonics device 100, the thin film nonlinear optical material may undergo a physical etch, for example using dry etching, reactive ion etching (RIE), inductively coupled plasma RIE. In some embodiments, a chemical etch and/or electron beam etch may be used. The waveguide may thus have improved surface roughness. For example, the sidewall(s) may have reduced surface roughness. For example, the short range root mean square surface roughness of a sidewall of the ridge may be less than ten nanometers. In some embodiments, this root mean square surface roughness is not more than five nanometers. In some cases, the short range root mean square surface roughness does not exceed two nanometers. Consequently, components of photonics device 100 may have low losses. In some embodiments, the total optical loss (i.e., the difference between the sum of the optical input power on all inputs and the sum of all optical output power on all outputs when optical device 100 is configured for minimal losses) may be not more than 10 dB for an electrical signal having a frequency range of 50-100 GHz. In some embodiments, the total optical loss may be not more than 7 or 8 dB for the same frequency range.

In some embodiments, waveguide 110 is a low optical loss waveguide. For example, waveguide 110 may have a total optical loss of not more than 10 dB through the portion of waveguide 110 (e.g. when biased at maximum transmission and as a maximum loss) in proximity to differential electrodes (not shown) of a modulator. In some embodiments, waveguide 110 has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, waveguide 110 has an optical loss of not more than 3 dB/cm (e.g. on average). In some embodiments, the nonlinear material(s) in waveguide 110 has an optical loss of not more than 2.0 dB/cm. In some such embodiments, waveguide 110 has an optical loss of not more than 1.0 dB/cm. In some embodiments, waveguide 110 has an optical loss of not more than 0.5 dB/cm. In some embodiments, the low optical losses are associated with a low surface roughness of the side walls of waveguide 110.

Waveguide 110 may have improved surface roughness. For example, the short range root mean square surface roughness of a sidewall of the ridge (described below) may be less than ten nanometers. In some embodiments, this root mean square surface roughness is not more than five nanometers. In some cases, the short range root mean square surface roughness does not exceed two nanometers. In some embodiments, the height of ridge is selected to provide a confinement of the optical mode such that there is a 10 dB reduction in intensity from the intensity at the center of ridge 114 at ten micrometers from the center of ridge. For example, the height of ridge may be on the order of a few hundred nanometers in some cases. However, other heights are possible in other embodiments. Various other optical components may be incorporated into waveguide 110 to provide the desired functionality.

Waveguide 110 is also configured such that the optical signal undergoes a mode transition while propagating through waveguide 110. Thus, waveguide 110 includes first portion 111, second portion 115, and transition portion 113 between first portion 113 and second portion 115. The optical signal has a first mode in first portion 111 and a second mode in second portion 115. The first mode transitions to the second mode in transition portion 113. Thus, transition portion 113 may be viewed as transferring the optical signal between the first portion and the second portion and transitioning between the first mode and the second mode. Although three portions 111, 1113, and 115 corresponding to one transition are shown, some embodiments may include more portions and multiple transitions (e.g. a third portion and an additional transition portion between the second and third portions.

The optical properties of the first mode in first portion 111 differ from the optical properties of the second mode in second portion 115. The difference(s) between the first and second modes may be significant or minor. For example, the first mode may have a first shape (e.g. more oval or trapezoidal), a first position in waveguide 110 (e.g. primarily confined in a ridge that may be further from an underlying substrate than a slab), and/or a first polarization (e.g. TE, TM, or a particular mix of TE and TM). The second mode may have a different shape (e.g. more circular), a second position in waveguide 110 (e.g. primarily confined in a slab), and/or a second polarization (e.g., TM, TE, or a different mix of TE and TM). Other differences between the first and second modes are possible. For example, the first and second modes may have one or more of different optical phase or group indices, different mode area, different mode shape, different polarization, different mode order (e.g. fundamental and higher order modes), and/or other differences. The changes in these properties of the modes of the optical signal occur in transition portion 113.

In order to provide the different modes in first portion 111 and second portion 115, the properties of waveguide 110 differ in regions 111 and 115. For example, waveguide 110 may be a ridge waveguide (i.e. including a slab portion and a ridge portion) in region 111 but a channel waveguide (e.g. including a slab portion only) in region 115 or vice versa. Similarly, the width, height, materials used, and/or other properties of waveguide 110 differ in regions 111 and 115. Thus, the properties of waveguide 110 change in transition portion 113 to support the differences between the modes. For example, the ridge may terminate, the ridge and/or slab may taper or inverse taper, and/or other differences in waveguide 110 may occur. Thus, modifications to waveguide 110 in transition portion 113 may include the removal of the ridge to move the optical mode (e.g. the transition of the optical mode from primarily confined in the ridge to being confined in the slab), the removal of the ridge for other reasons, and/or transitions that support other types of changes to or applications for the optical modes. For example, a transition between a channel and a ridge waveguide may be used for reducing the minimum bend radius in waveguide 110 or realizing spot-size converters that are used to interface with conventional optical fibers. Thus, the structural or other waveguide changes in transition portion 113 may either intentionally change the mode or maintain the same mode. Transition portion 113 may occur on the integrated circuit (e.g. a photonics integrated circuit) rather than at a mode converter for off-chip coupling. Stated differently, transition portion 111 may be located somewhere on-chip within the photonics device (i.e. not at or proximate to an edge).

Without more, the changes to waveguide 110 in transition portion 113 may cause optical losses as the first mode of the optical signal in first portion 111 transitions to the second mode of the optical signal in second portion 115 (or vice versa). It has been determined that these optical losses may be due to the abrupt change in the index of refraction experienced by the optical modes in transition portion 113. Consequently, index smoothing structure 150 is present.

Index smoothing structure 150 corresponds to transition portion 113. In some embodiments, index smoothing structure 150 is proximate to or within transition portion 113. Index smoothing structure 150 may be configured to more gradually change the effective index of refraction for the optical signal propagating through waveguide 110. The effective index of refraction is the index of refraction experienced by the optical mode and may have contributions from multiple materials. For example, the effective index of refraction may include contributions from the TFLCEO material of waveguide 110, the surrounding cladding, and/or the underlying substrate structure (e.g. a buried oxide (BOX) layer and/or the substrate below the BOX layer). The properties of index smoothing structure 150 thus depend upon the differences between the first mode and the second mode and the properties of transition portion 113. Stated differently, the configuration of index smoothing structure 150 depends the type of mode conversion being carried out in waveguide 110. For example, index smoothing structure 150 may have one structure (e.g. geometry and/or materials) for a transition portion 113 that performs a polarization rotation, another structure for a transition portion 113 that expands the size of the mode, and yet another structure for a transition portion 113 that moves the mode from being confined in a ridge to being confined in a slab.

Index smoothing structure 150 is configured to transition a first effective index of refraction for the first mode in first portion 111 to a second effective index of refraction for the second mode in second portion 113. Index smoothing structure 150 may thus have an intermediate effective index of refraction between the first and second effective indices of refraction. Further, the intermediate effective index of refraction may vary across (perpendicular to the direction of propagation of the optical signal) and/or along (parallel to the direction of propagation of the optical signal) transition portion 113. Index smoothing structure 150 may also be viewed as providing a better match to the first and second optical modes in waveguide portions 111 and 115. For example, index smoothing structure 150 may be configured such that a transition portion optical mode (i.e. the optical mode in transition portion 113) has at least an eighty percent match (or overlap) with the first optical mode and with the second optical mode. Thus, in some embodiments, the transition portion optical mode changes through transition portion 113. In some embodiments, index smoothing structure 150 may be configured such that the transition portion optical mode has at least (or greater than) an eighty percent match with the first optical mode and the second optical mode. In some embodiments, index smoothing structure 150 may be configured such that the transition portion optical mode has at least an eighty-five percent match with the first optical mode and the second optical mode. In some embodiments, index smoothing structure 150 may be configured such that the transition portion optical mode has at least a ninety percent match with the first optical mode and the second optical mode. In some embodiments, index smoothing structure 150 may be configured such that the transition portion optical mode has at least a ninety-five percent match with the first optical mode and the second optical mode. in some embodiments, the match is not more than ninety nine percent. Thus, because index smoothing structure gradually changes the effective index of refraction, the mode may be viewed as more gradually changing. Thus, the transition portion optical mode may better match the first and second modes. Thus, losses may be reduced.

Index smoothing structure 150 may also be viewed as reducing optical losses through transition portion 111. In some embodiments, index smoothing structure 150 is configured such that the optical losses through transition portion 113 may be not more than 1.5 dB. In some embodiments, index smoothing structure 150 is configured such that the optical losses are not more than 1 dB. Index smoothing structure 150 may be configured such that optical losses are not more than 0.5 dB or not more than 0.25 dB. In some embodiments, the optical losses are at least 0.01 dB.

In some embodiments, index smoothing structure 150 includes one or more sub-wavelength features (not explicitly shown in FIG. 1) and/or one or more overlay structures (not explicitly shown in FIG. 1). The sub-wavelength features and/or overlay structure may be configured such that the effective optical index of refraction in transition portion 113 undergoes a more gradual change. The sub-wavelength feature(s) each have a dimension less than a wavelength of the optical signal. In some embodiments, the dimension of the sub-wavelength feature(s) is not more than 0.1 multiplied by the wavelength of the optical signal, not more than ¼ of the wavelength of the optical signal, or not more than ½ of the wavelength of the optical signal. In some embodiments, multiple sub-wavelength features are present. A sub-wavelength feature has a pitch, a shape, and size(s). The pitch, shape, and/or size may be constant or vary. Further, the sub-wavelength features can, but need not be aligned (e.g. need not be aligned along the direction of propagation of the optical signal). The sub-wavelength features may be configured such that scattering and other interactions between the optical signal and the sub-wavelength feature(s) are reduced or avoided. Thus, the optical mode for the optical signal experience the sub-wavelength features as a variation in the optical index of refraction (i.e. a different effective index of refraction).

Similarly, the overlay structure affects the index of refraction experienced by the optical mode in at least the transition portion. In some embodiments, an optical material is adjacent to the waveguide. The optical material (e.g., cladding) has a particular index of refraction. In such embodiments, the overlay structure has an overlay index of refraction greater than the particular index of refraction (e.g. greater than the index of refraction of the cladding). In some embodiments, the index of refraction of the overlay structure is less than that of waveguide 110. In other embodiments, the index of refraction of the overlay structure may be greater than or equal to the index of refraction of waveguide 110. For example, the overlay structure may include at least one of silicon nitride, silicon, TFLCEO material(s) such as LN and/or LT, silicon oxynitride, doped silicon, aluminum nitride, or titanium doped silicon dioxide. In some such embodiments, the overlay structure consists of such materials. The overlay structure may intersect a transition optical mode of the optical signal for transition portion 113. Because the overlay structure intersects the transition optical mode, the overlay structure can affect the optical mode. In some embodiments, the overlay structure is not more than one micrometer from the waveguide. In some embodiments, the overlay structure shares an interface with the waveguide. In some embodiments, the overlay structure is separated from the waveguide by at least twenty nanometers, at least fifty nanometers, at least one hundred nanometers, or at least one hundred and fifty nanometers. Although termed an overlay structure, the location of the overlay structure may be above (waveguide 110 closer to the substrate than at least part of the overlay structure) or below (e.g. at least a portion of the overlay structure is closer to the substrate than waveguide 110) waveguide 110.

Thus, the materials used, geometry, placement, and other aspects of the configuration of the overlay structure and/or sub-wavelength features may be engineered to more gradually change the optical mode from the first mode to the second mode. Consequently, the configuration of the sub-wavelength feature(s) and/or the overlay structure(s) may depend upon the transition the optical mode undergoes. In some embodiments, other structures may be used by index smoothing structure 150.

Index smoothing structure 150 may improve the performance of photonics devices. In particular, index smoothing structure 150 may allow for a more gradual change in the effective index of refraction, reduced losses, reduced polarization dependent losses, and/or improved mode matching. Further, with judicious selection of the materials used consistent with TFLCEO and/or CMOS processing and/or appropriate selection of the dimensions of index smoothing structure 150, formation index smoothing structure 150 may be more readily integrated into manufacturing of photonics device 100. Thus, performance may be improved without unduly complicating manufacturing.

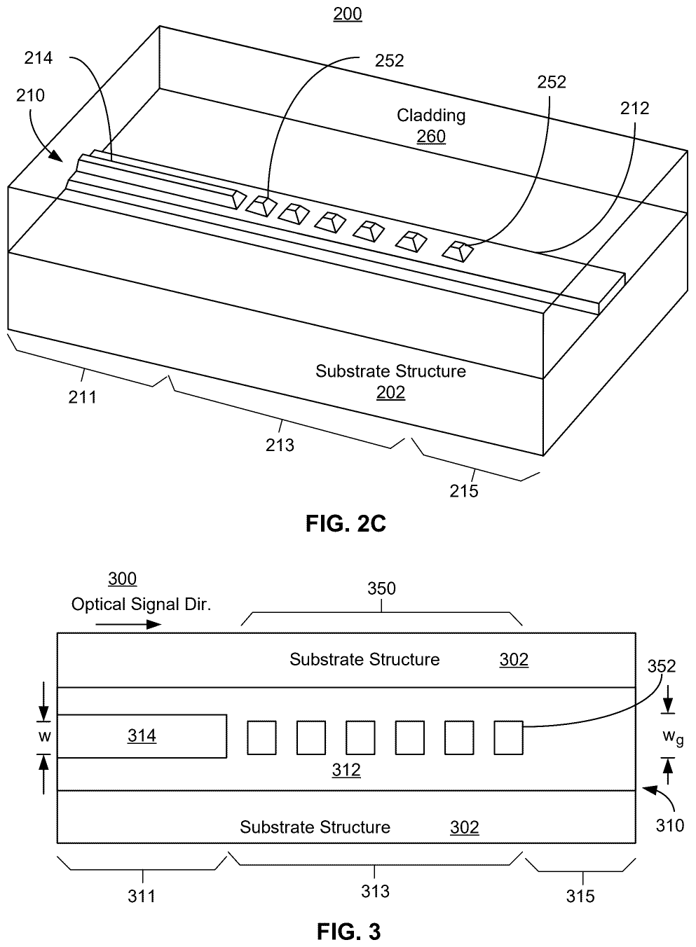

FIGS. 2A, 2B, and 2C depict an embodiment of a portion of photonics device 200 having a mode transition. FIG. 2A depicts a side view of photonics device 200. FIG. 2B depicts a plan view of photonics device 200. FIG. 2C depicts a perspective view of photonics device 200. Photonics device 200 includes waveguide 210 having first portion 211, transition portion 213, and second portion 215 that are analogous to waveguide 110, first portion 111, transition portion 113, and second portion 115. Similarly, photonics device 200 includes index smoothing structure 250 analogous to index smoothing structure 150. Index smoothing structure 250 includes sub-wavelength features 252. Although a particular number of sub-wavelength features 252 are shown, another number may be present. Also shown is substrate structure 202. Substrate structure 202 may include an underlying substrate such as silicon, a BOX layer, and/or other structures.

Waveguide 210 includes slab 212 and ridge 214 in first portion 211. Thus, waveguide 210 is a ridge waveguide in first portion 211. A ridge waveguide may also be known as a rib waveguide. Waveguide 210 includes only slab 212 in portions 213 and 215. Thus, waveguide 210 is a channel waveguide in transition portion 213 and second portion 215. A channel waveguide has a single rib or wire (e.g. the slab only or the ridge only). The channel waveguide may also be known as a rib waveguide. In some embodiments, slab 212 and ridge 214 are formed of the same material(s). In other embodiments, slab 212 may include different material(s) from ridge 214. In some embodiments, slab 212 and ridge 214 include (e.g. contain or consist of) TFLCEO material(s). Because ridge 214 terminates at transition portion 213, waveguide 210 may be viewed as having an abrupt change in effective index of refraction in transition portion 213.

Index smoothing structure 250, and thus sub-wavelength features 252, extend along a length, L, in the optical signal direction. Although optical signal is depicted as traveling in a particular direction, one of ordinary skill in the art will recognize that other directions of propagation (e.g. in the opposite direction) are possible. Sub-wavelength features 252 also have dimensions l (length-along the direction of propagation), w (width transverse to the direction of propagation), and h (height, or thickness). One or more of dimensions l, w, and/or h are less than the wavelength of the optical signal. For example, w or 1 and 2 may be less than the wavelength. In some embodiments, all dimensions of sub-wavelength features 252 are less than the wavelength of the optical signal. In some embodiments, the dimension(s) of sub-wavelength features 252 are not more than ½ multiplied by the wavelength of the optical signal. In some embodiments, the dimension(s) are not more than ¼ multiplied by the wavelength of the optical signal. The dimension(s) may be not more than ⅛ multiplied by the wavelength of the optical signal. The dimension(s) are still fabricable using lithographic techniques in some embodiments. For example, the dimensions may be at least 0.01 multiplied by the wavelength of the optical signal (which may be at least 400 nanometers and not more than 1700 nanometers in some embodiments). Sub-wavelength feature(s) 252 may reside directly on the slab as shown or may be spaced apart (e.g. by a thin layer of cladding). In some embodiments, sub-wavelength features 252 may be formed of the same material(s) as waveguide 210. Sub-wavelength features 252 may extend a distance, L, equal to at least three multiplied by the wavelength of the optical signal in waveguide 210. In some embodiments, the length, L, that sub-wavelength features 252 extend is at least two micrometers long and not more than twenty micrometers long. Other lengths may be possible. Also shown in FIG. 2B is the pitch, p, of sub-wavelength features 252.

Index smoothing structure 250 may mitigate optical losses in photonics device 200. Ridge 214 terminates near the left edge of transition portion 213. Without the presence of index smoothing structure 250, light propagating from left to right experiences the abrupt termination (e.g. an abrupt change in the effective index of refraction for the mode). This abrupt change may cause high loss for light polarized out of plane (TM) compared to light polarized in plane (TE). Such losses, particularly polarization dependent losses, are undesirable. For example, in some cases, TE polarized light (polarized in-plane) may experience approximately 0.24 dB loss, while TM polarized light (polarized perpendicular to plane) may experience a greater than 2 dB loss. Stated differently, TE polarized light may experience a 2-3% optical loss, while TM polarized light may experience a 14-15% optical loss. The presence of sub-wavelength features 252 mitigates the abruptness of the change in effective index of refraction. As a result, the losses, particularly for TM polarized light may be reduced. For example, optical losses through transition portion 213 may be not more than 1.5 dB. In some embodiments, index smoothing structure 250 is configured such that the optical losses are not more than 1 dB. Index smoothing structure 250 may be configured such that optical losses are not more than 0.5 dB or not more than 0.25 dB. In some embodiments, the optical losses are at least 0.01 dB. For example, both TE and TM polarized light may experience optical losses of not more than five percent for transition portion 213. In some embodiments, index smoothing structure 250 also allows improved matching of the optical mode in transition portion 213 with the first and second optical modes of regions 211 and 215 in a manner analogous to index smoothing structure 150 (e.g. at least an eighty percent, eighty-five percent, ninety-percent or ninety-five percent match). Thus, the polarization dependence of the losses in photonics device 200 may be reduced. Further, overall losses may be mitigated.

Moreover, the use of sub-wavelength features 252 may allow for tunability of transition portion 213 without modification of an existing process. For example, sub-wavelength features 252 may be formed of the same materials as ridge 214, so long as the feature size requirements can be met by fabrication processes used. In some embodiments, the same etch(es) that define ridge 214 may be used to define sub-wavelength features 252. Thus, not only can performance be improved, but it may also be accomplished without significantly complicating manufacturing.

FIG. 3 depicts a plan view of an embodiment of a portion of photonics device 300 having a mode transition. Photonics device 300 includes waveguide 310 having first portion 311, transition portion 313, and second portion 315 that are analogous to waveguide 210, first portion 211, transition portion 213, and second portion 215. Waveguide 310 includes slab 312 and ridge 314 in first portion 311. Waveguide 310 includes only slab 312 in portions 313 and 315. Thus, ridge 314 and slab 312 are analogous to ridge 214 and slab 212, respectively. Also shown is substrate structure 302 analogous to substrate structure 202.

Photonics device 300 includes index smoothing structure 350 analogous to index smoothing structure 250. Index smoothing structure 350 includes sub-wavelength features 352 analogous to sub-wavelength features 252. Although a particular number of sub-wavelength features 352 are shown, another number may be present. In the embodiment shown, ridge 314 has width w_{g}, while sub-wavelength features 352 have width w that is different from w_{g}. In the embodiment shown, sub-wavelength features 352 are narrower than ridge 314. In other embodiments, sub-wavelength features 352 may be wider than ridge 314.

Index smoothing structure 350 may function in an analogous manner to and provide benefits analogous to index smoothing structure 250. Photonics device 300 may share the benefits of photonics device 200. In particular, index smoothing structure 350 may allow for a more gradual change in the effective index of refraction, reduced losses, reduced polarization dependent losses, and/or improved mode matching. Further, formation index smoothing structure 350 may be more readily integrated into manufacturing of photonics device 300. Thus, performance may be improved without unduly complicating manufacturing.

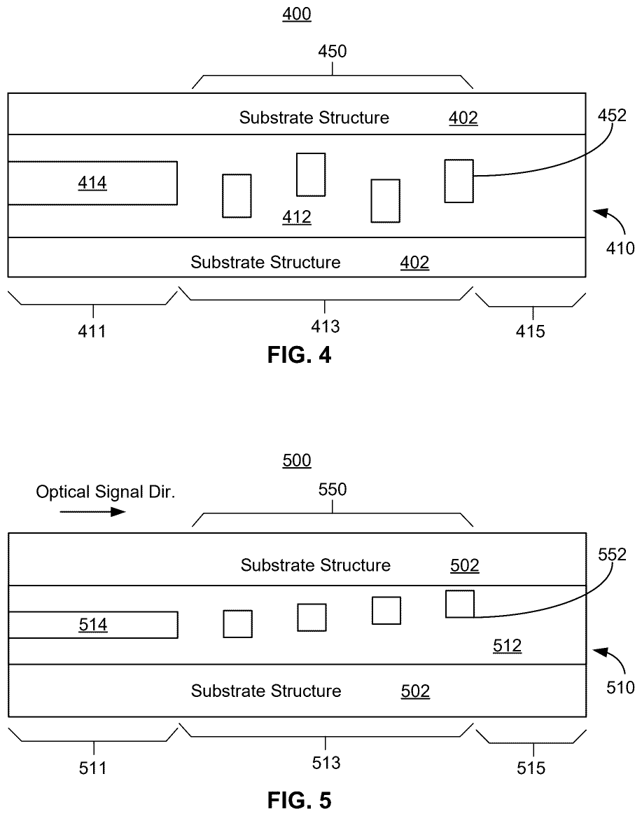

FIG. 4 depicts a plan view of an embodiment of a portion of photonics device 400 having a mode transition. Photonics device 400 includes waveguide 410 having first portion 411, transition portion 413, and second portion 415 that are analogous to waveguide 210, first portion 211, transition portion 213, and second portion 215. Waveguide 410 includes slab 412 and ridge 414 in first portion 411. Waveguide 410 includes only slab 412 in portions 413 and 415. Thus, ridge 414 and slab 412 are analogous to ridge 214 and slab 212, respectively. Also shown is substrate structure 402 analogous to substrate structure 202.

Photonics device 400 includes index smoothing structure 450 analogous to index smoothing structure 250. Index smoothing structure 450 includes sub-wavelength features 452 analogous to sub-wavelength features 252. Although a particular number of sub-wavelength features 452 are shown, another number may be present. In the embodiment shown, sub-wavelength features 452 are offset from the center of waveguide 410. The offsets shown in FIG. 4 are symmetrical, but need not be. Although a particular pattern of offsets is shown, other offsets might be used. The offsets may be used to provide the desired change in effective index of refraction and/or mode matching for transition portion 413.

Index smoothing structure 450 may function in an analogous manner to and provide benefits analogous to index smoothing structure 250. Photonics device 400 may share the benefits of photonics device 200. In particular, index smoothing structure 450 may allow for a more gradual change in the effective index of refraction, reduced losses, reduced polarization dependent losses, and/or improved mode matching. Further, formation index smoothing structure 450 may be more readily integrated into manufacturing of photonics device 400. Thus, performance may be improved without unduly complicating manufacturing.

FIG. 5 depicts a plan view of an embodiment of a portion of photonics device 500 having a mode transition. Photonics device 500 includes waveguide 510 having first portion 511, transition portion 513, and second portion 515 that are analogous to waveguide 210, first portion 211, transition portion 213, and second portion 215. Waveguide 510 includes slab 512 and ridge 514 in first portion 511. Waveguide 510 includes only slab 512 in portions 513 and 515. Thus, ridge 514 and slab 512 are analogous to ridge 214 and slab 212, respectively. Also shown is substrate structure 502 analogous to substrate structure 202.

Photonics device 500 includes index smoothing structure 550 analogous to index smoothing structure 250. Index smoothing structure 550 includes sub-wavelength features 552 analogous to sub-wavelength features 252. Although a particular number of sub-wavelength features 552 are shown, another number may be present. In the embodiment shown, sub-wavelength features 552 are offset from the center of waveguide 510. Thus, index smoothing structure 550 is analogous to index smoothing structure 400. The offsets shown in FIG. 5 are asymmetrical, but need not be. Although certain offsets are shown in FIG. 5, other offsets may be used. The offsets may be used to provide the desired change in effective index of refraction and/or mode matching for transition portion 513.

Index smoothing structure 550 may function in an analogous manner to and provide benefits analogous to index smoothing structure 250. Photonics device 500 may share the benefits of photonics device 200. In particular, index smoothing structure 550 may allow for a more gradual change in the effective index of refraction, reduced losses, reduced polarization dependent losses, and/or improved mode matching. Further, formation index smoothing structure 550 may be more readily integrated into manufacturing of photonics device 500. Thus, performance may be improved without unduly complicating manufacturing.

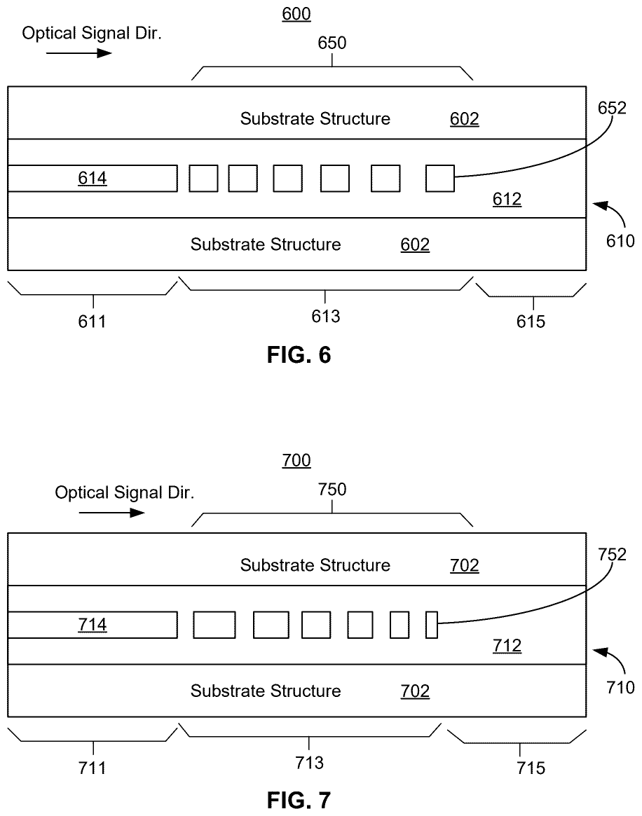

FIG. 6 depicts a plan view of an embodiment of a portion of photonics device 600 having a mode transition. Photonics device 600 includes waveguide 610 having first portion 611, transition portion 613, and second portion 615 that are analogous to waveguide 210, first portion 211, transition portion 213, and second portion 215. Waveguide 610 includes slab 612 and ridge 614 in first portion 611. Waveguide 610 includes only slab 612 in portions 613 and 615. Thus, ridge 614 and slab 612 are analogous to ridge 214 and slab 212, respectively. Also shown is substrate structure 602 analogous to substrate structure 202.

Photonics device 600 includes index smoothing structure 650 analogous to index smoothing structure 250. Index smoothing structure 650 includes sub-wavelength features 652 analogous to sub-wavelength features 252. Although a particular number of sub-wavelength features 652 are shown, another number may be present. In the embodiment shown, sub-wavelength features 652 have a pitch that varies. In the embodiment shown, the pitch (distance between sub-wavelength features 652) increases with increasing distance from ridge 614. Although a certain pitch is shown in FIG. 6, other pitches may be used. The variation in pitch may be used to provide the desired change in effective index of refraction and/or mode matching for transition portion 613.

Index smoothing structure 650 may function in an analogous manner to and provide benefits analogous to index smoothing structure 250. Photonics device 600 may share the benefits of photonics device 200. In particular, index smoothing structure 650 may allow for a more gradual change in the effective index of refraction, reduced losses, reduced polarization 650 may be more readily integrated into manufacturing of photonics device 600. Thus, performance may be improved without unduly complicating manufacturing.

FIG. 7 depicts a plan view of an embodiment of a portion of photonics device 700 having a mode transition. Photonics device 700 includes waveguide 710 having first portion 711, transition portion 713, and second portion 715 that are analogous to waveguide 210, first portion 211, transition portion 213, and second portion 215. Waveguide 710 includes slab 712 and ridge 714 in first portion 711. Waveguide 710 includes only slab 712 in portions 713 and 715. Thus, ridge 714 and slab 712 are analogous to ridge 214 and slab 212, respectively. Also shown is substrate structure 702 analogous to substrate structure 202.

Photonics device 700 includes index smoothing structure 750 analogous to index smoothing structure 250. Index smoothing structure 750 includes sub-wavelength features 752 analogous to sub-wavelength features 252. Although a particular number of sub-wavelength features 752 are shown, another number may be present. In the embodiment shown, sub-wavelength features 752 have a pitch that varies. Thus, index smoothing structure 750 is analogous to index smoothing structure 650. In the embodiment shown, the pitch (distance between sub-wavelength features 752) decreases with increasing distance from ridge 714. Although a certain pitch is shown in FIG. 7, other pitches may be used. The variation in pitch may be used to provide the desired change in effective index of refraction and/or mode matching for transition portion 713. In addition, the lengths of sub-wavelength features 752 vary. In the embodiment shown, the lengths decrease with increasing distance from ridge 714. In other embodiments, the lengths, widths, and/or heights may vary in another manner. In some embodiments, the pitch may vary while the dimension(s) of sub-wavelength structures 752 is constant. In other embodiments, the pitch may be constant while the dimension(s) of sub-wavelength structures 752 may vary.

Index smoothing structure 750 may function in an analogous manner to and provide benefits analogous to index smoothing structure 250. Photonics device 700 may share the benefits of photonics device 200. In particular, index smoothing structure 750 may allow for a more gradual change in the effective index of refraction, reduced losses, reduced polarization 750 may be more readily integrated into manufacturing of photonics device 700. Thus, performance may be improved without unduly complicating manufacturing.

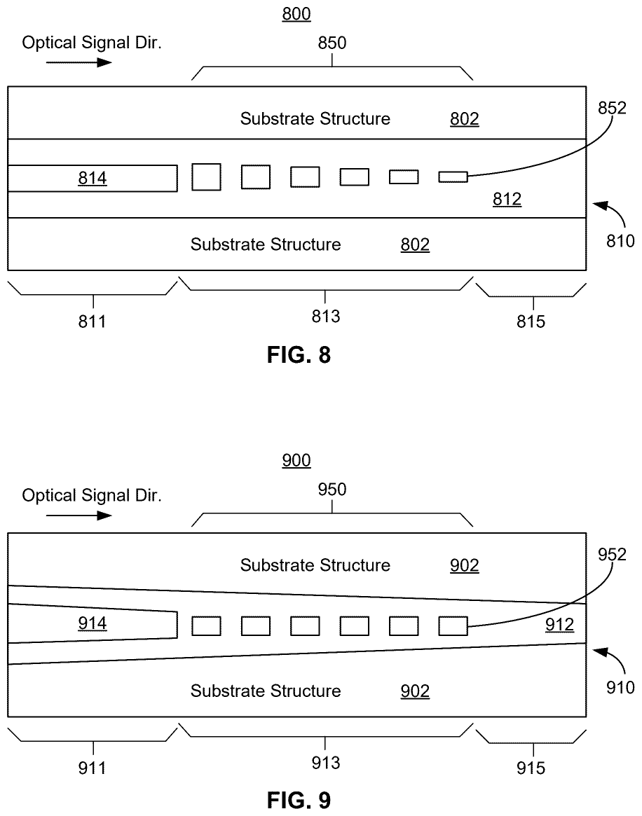

FIG. 8 depicts a plan view of an embodiment of a portion of photonics device 800 having a mode transition. Photonics device 800 includes waveguide 810 having first portion 811, transition portion 813, and second portion 815 that are analogous to waveguide 210, first portion 211, transition portion 213, and second portion 215. Waveguide 810 includes slab 812 and ridge 814 in first portion 811. Waveguide 810 includes only slab 812 in portions 813 and 815. Thus, ridge 814 and slab 812 are analogous to ridge 214 and slab 212, respectively. Also shown is substrate structure 802 analogous to substrate structure 202.

Photonics device 800 includes index smoothing structure 850 analogous to index smoothing structure 250. Index smoothing structure 850 includes sub-wavelength features 852 analogous to sub-wavelength features 252. Although a particular number of sub-wavelength features 852 are shown, another number may be present. In the embodiment shown, sub-wavelength features 852 have a width that varies. In the embodiment shown, the width decreases with increasing distance from ridge 814. The lengths and/or heights of sub-wavelength structures may also vary. Although a certain variation in width is shown in FIG. 8, other variations may be used. The variation in dimension(s) may be used to provide the desired change in effective index of refraction and/or mode matching for transition portion 813.

Index smoothing structure 850 may function in an analogous manner to and provide benefits analogous to index smoothing structure 250. Photonics device 800 may share the benefits of photonics device 200. In particular, index smoothing structure 850 may allow for a more gradual change in the effective index of refraction, reduced losses, reduced polarization dependent losses, and/or improved mode matching. Further, formation index smoothing structure 850 may be more readily integrated into manufacturing of photonics device 800. Thus, performance may be improved without unduly complicating manufacturing.

FIG. 9 depicts a plan view of an embodiment of a portion of photonics device 900 having a mode transition. Photonics device 900 includes waveguide 910 having first portion 911, transition portion 913, and second portion 915 that are analogous to waveguide 210, first portion 211, transition portion 213, and second portion 215. Waveguide 910 includes slab 912 and ridge 914 in first portion 911. Waveguide 910 includes only slab 912 in portions 913 and 915. Thus, ridge 914 and slab 912 are analogous to ridge 214 and slab 212, respectively. Also shown is substrate structure 902 analogous to substrate structure 202. Photonics device 900 includes index smoothing structure 950 analogous to index smoothing structure 250. Index smoothing structure 950 includes sub-wavelength features 952 analogous to sub-wavelength features 252. Although a particular number of sub-wavelength features 952 are shown, another number may be present.

Ridge 914 and slab 912 have widths that vary. In the embodiment shown, the widths of ridge 914 and slab 912 decrease in the optical signal direction. In other embodiments, the width may vary in another manner. Further, the heights of ridge 914 and slab 912 may also be varied.

Index smoothing structure 950 may function in an analogous manner to and provide benefits analogous to index smoothing structure 250. Photonics device 900 may share the benefits of photonics device 200. In particular, index smoothing structure 950 may allow for a more gradual change in the effective index of refraction, reduced losses, reduced polarization dependent losses, and/or improved mode matching. Further, formation index smoothing structure 950 may be more readily integrated into manufacturing of photonics device 900. In addition, waveguide 910 may be configured for its desired function, for example by varying the width, height, and/or presence of ridge 914 and/or slab 912. Thus, performance may be improved without unduly complicating manufacturing.

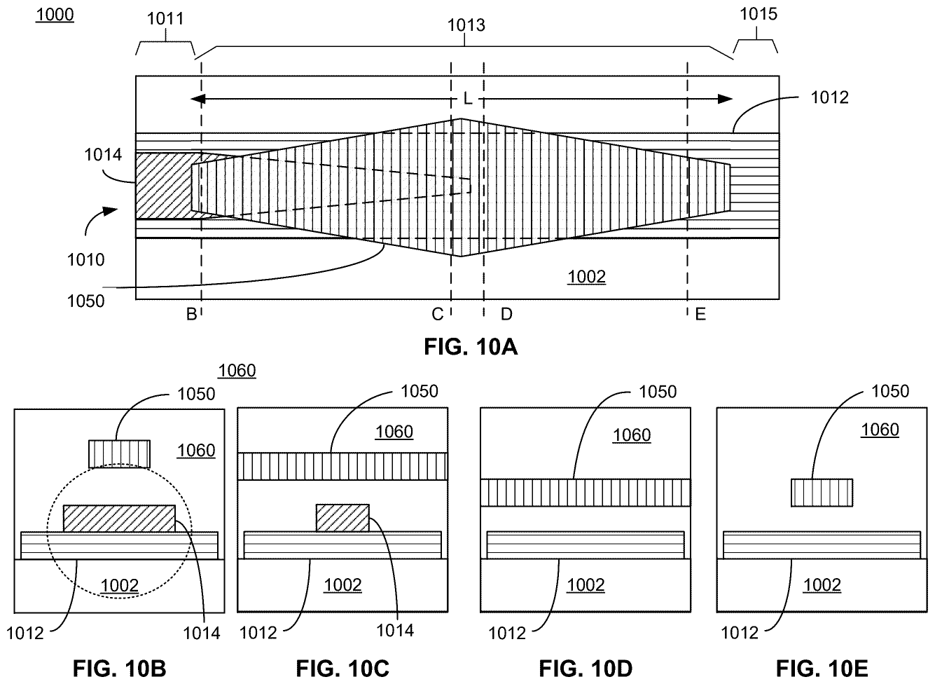

FIGS. 10A-10E depict an embodiment of a portion of photonics device 1000 having a mode transition. FIG. 10A depicts a plan view of photonics device 1000. FIG. 10B depicts a cross-sectional view of photonics device 1000 along dashed line B. FIG. 10C depicts a cross-sectional view of photonics device 1000 along dashed line C. FIG. 10D depicts a cross-sectional view of photonics device 1000 along dashed line D. FIG. 10E depicts a cross-sectional view of photonics device 1000 along dashed line E.

Photonics device 1000 includes waveguide 1010 having first portion 1011, transition portion 1013, and second portion 1015 that are analogous to waveguide 110, first portion 111, transition portion 113, and second portion 115. Similarly, photonics device 1000 includes index smoothing structure 1050 analogous to index smoothing structure 150. Index smoothing structure 1050 is an overlay structure 1050. Although a contiguous overlay structure 1050 is shown, in some embodiments, the overlay structure may have multiple separate pieces. Also shown are substrate structure 1002 that may be analogous to substrate structure 202.

Waveguide 1010 includes slab 1012 and ridge 1014 in first portion 1011. Thus, waveguide 1010 is a ridge waveguide in first portion 1011. Waveguide 1010 includes only slab 1012 in portions 1013 and 1015. Thus, waveguide 1010 is a channel waveguide in transition portion 1013 and second portion 1015. some embodiments, slab 1012 and ridge 1014 are formed of the same material(s). In other embodiments, slab 1012 may include different material(s) from ridge 1014. In some embodiments, slab 1012 and ridge 1014 include (e.g. contain or consist of) TFLCEO material(s). Because ridge 1014 terminates at transition portion 1013, waveguide 1010 may be viewed as having an abrupt change in effective index of refraction in transition portion 1013. In addition, cladding 1060 is shown. Cladding 1060 may include material(s) having a lower index of refraction than waveguide 1010. For example, cladding 1060 may include silicon dioxide.

Index smoothing structure (i.e. overlay structure) 1050 extends along a length, L, in the optical signal direction. Although the optical signal is depicted as traveling in a particular direction, one of ordinary skill in the art will recognize that other directions of propagation (e.g. in the opposite direction) are possible. Overlay structure 1050 widens as ridge 1014 tapers, then narrows along the direction of propagation of the optical signal. For example, in some embodiments, overlay structure 1050 may have a maximum width of approximately 0.1 micrometer through 3 micrometers and a length (L) of at least one micrometer though fifty micrometers or more. However, overlay structure 1050 may have different dimensions and/or a different shape depending upon the configuration of waveguide 1110 and the applications for which photonics device 1000 is used.

Overlay structure 1050 has an effective index of refraction greater than that of cladding 1012. In some embodiments, overlay structure 1050 has an effective index of refraction less than that of waveguide 1010. In some embodiments, structure 1050 has an effective index of refraction the same as that of waveguide 1010. structure 1050 has an effective index of refraction greater than that of waveguide 1010. The effective index of refraction (and thus the material(s)) and geometry selected for overlay structure 1050 depends upon the application for which overlay structure 1050 is used. In addition, overlay structure 1050 may include or consist of a material (or materials) that is compatible with TFLCEO material (e.g. TFLN and/or TFLT) processing and/or CMOS processing. Thus, the material(s) used for overlay structure 1050 may also be desired to be easily patterned, inorganic. These characteristics, as well as an index of refraction lower than TFLN/TFLN and higher than cladding materials such as SiO₂, are features of silicon nitride. Thus, silicon nitride is a material that may be used for overlay structure 1050. In some embodiments, overlay structure 1050 may include one or more of silicon, lithium niobate, silicon oxide nitride, doped silicon, aluminum nitride, or titanium doped SiO₂. In some embodiments, overlay structure 1050 may consist of one or more of such material(s).

In some embodiments, at least part of overlay structure 1050 is separated from waveguide 1010. For example, the distance between a portion of overlay structure 1050 and a corresponding portion of waveguide 1010 may be by a least 20 nanometers, at least 50 nanometers, at least 100 nanometers, at least 150 nanometers, at least one micrometer, and not more than 10 micrometers. In some embodiments, overlay structure(s) 1050 reside directly on the waveguide 1100. In some embodiments, waveguide 1010 is on overlay structure 1050. However, overlay structure(s) 1050 are close enough to be in contact with the optical mode(s) in waveguide 1010. For example, one such case is depicted in FIG. 10B. The optical mode in transition portion 1011 (shown by the dotted line) intersects overlay structure 1050. The distance between overlay structure 1050 and waveguide 1010 may depend upon the application for which overlay structure 1050 is used. For example, if transition portion 1013 is a mode expander, overlay structure 1050 may be at least one micrometer and not more than 10 micrometers from a corresponding portion of waveguide 1010. The length of the transition portion 1013 and overlay structure 1050 may be sufficiently long to facilitate a low loss transition. In some embodiments, this length, L, may range from at least five micrometers to not more than 500 micrometers depending on the application. For example, the length may be at least five micrometers and not more than twenty-five micrometers if the goal is to enable low loss in transitioning between ridge and channel waveguides (e.g. between first portion 1011 and second portion 1013). The length may be at least 100 micrometers and not more than 300 micrometers, or more if overlay structure is used in conjunction with off-chip coupling/spot-size converters or polarization rotation.

Overlay structure 1050 may mitigate optical losses in photonics device 1000. Ridge 1014 terminates near the left edge of transition portion 1013. Without the presence of overlay structure 1050, light propagating from left to right experiences the abrupt termination (e.g. an abrupt change in the effective index of refraction for the mode). This abrupt change may cause high polarization dependent losses. Thus, the issues faced by photonics device 1000 in the absence of overlay structure are analogous to those faced by photonics device 200 in the absence of sub-wavelength features 252. Overlay structure 1050 may more gradually change the effective index of refraction experienced by the optical mode in transition portion 1013, improve the matching of the optical mode in transition portion 1013 with the first optical mode in first portion 1011 and/or with the second optical mode in second portion 1015.

For example, for a silicon nitride overlay structure 1010, TM transmission may be significantly increased (e.g. by a range of over 10% or over 20%). Thus, the total optical losses for photonics device 100 may be reduced and the polarization dependent losses mitigated. In some embodiments, the optical losses for photonics device for the TE mode are 0.1-0.3 dB for TE mode(s) and 0.1-0.3 dB for TM modes; 0.3-1 dB for TE and 0.3-1 dB for TM, or 1-5 dB for TE, 1-5 dB for TM. In some embodiments, |TE losses−TM losses|<0.8 dB, |TE losses−TM losses| <0.5 dB, or |TE losses−TM losses|<0.3 dB. The loss ranges are possible. In some embodiments, overlay structure 1050 also allows improved matching of the optical mode in transition portion 1013 with the first and second optical modes of regions 1011 and 1015 in a manner analogous to index smoothing structure 150 (e.g. at least an eighty percent, eighty-five percent, ninety-percent or ninety-five percent match). Thus, the polarization dependence of the losses in photonics device 1000 may be reduced. Further, overall losses may be mitigated.

Photonics device 1000 may thus have improved performance. In particular, overlay structure 1050 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1050 may be more readily integrated into manufacturing of photonics device 1000. Thus, performance may be improved without unduly complicating manufacturing.

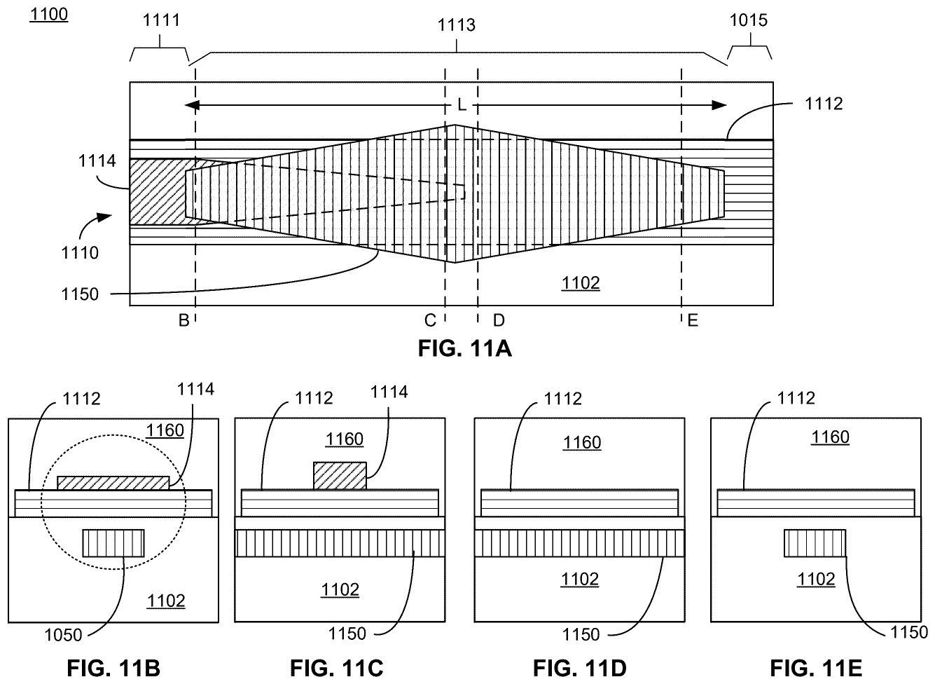

FIGS. 11A-11E depict an embodiment of a portion of photonics device 1100 having a mode transition. FIG. 11A depicts a plan view of photonics device 1100. FIG. 11B depicts a cross-sectional view of photonics device 1100 along dashed line B. FIG. 11C depicts a cross-sectional view of photonics device 1100 along dashed line C. FIG. 11D depicts a cross-sectional view of photonics device 1100 along dashed line D. FIG. 11E depicts a cross-sectional view of photonics device 1100 along dashed line E.

Photonics device 1100 includes waveguide 1110 having first portion 1111, transition portion 1113, and second portion 1115 that are analogous to waveguide 1010, first portion 1011, transition portion 1013, and second portion 1015. Similarly, photonics device 1100 includes index smoothing structure 1150 (i.e. overlay structure 1150) analogous to overlay structure 1050. Although a contiguous overlay structure 1150 is shown, in some embodiments, the overlay structure may have multiple separate pieces. Also shown are substrate structure 1102 and cladding 1060 that may be analogous to substrate structure 1002 and cladding 1060.

Waveguide 1110 includes slab 1112 and ridge 1114 that are analogous to slab 1012 and ridge 1014. Waveguide 1110 includes first portion 1111, transition portion 1113, and second portion 1113 that are analogous to first portion 1011, transition portion 1113, and second portion 1115. Overlay structure 1150 is analogous to overlay structure 1050, but resides below waveguide 1110 (e.g. between waveguide 1110 and at least a portion of substrate structure 1102).

Overlay structure 1150 may function in an analogous manner to and provide benefits analogous to overlay structure 1050. Thus, photonics device 1100 may share the benefits of photonics device 1000. In particular, overlay structure 1150 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1150 may be more readily integrated into manufacturing of photonics device 1100. Thus, performance may be improved without unduly complicating manufacturing.

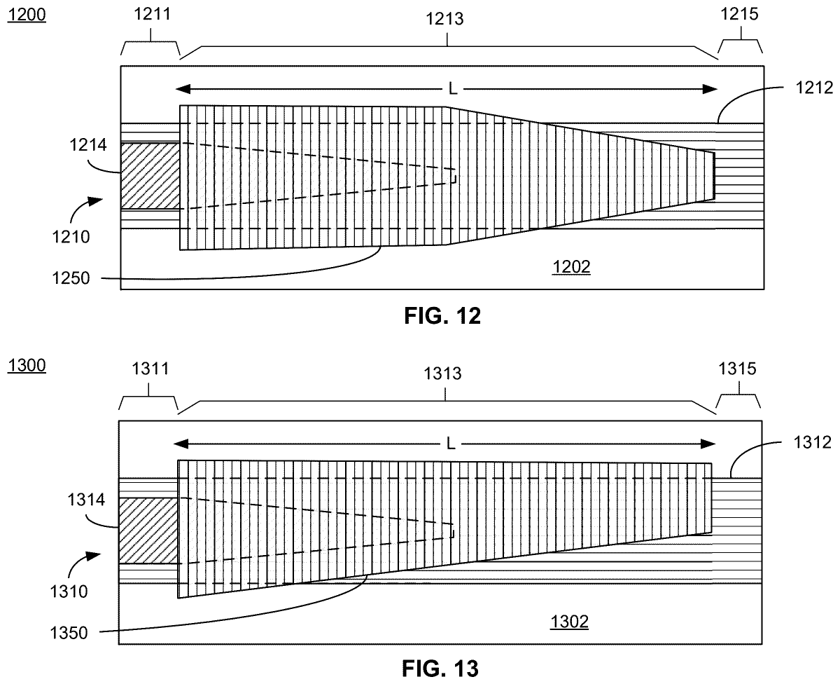

FIG. 12 depicts a plan view of an embodiment of a portion of photonics device 1200 having a mode transition. Photonics device 1200 includes waveguide 1210 having first portion 1211, transition portion 1213, and second portion 1215 that are analogous to waveguide 1010, first portion 1011, transition portion 1013, and second portion 1015. Similarly, photonics device 1200 includes index smoothing structure 1250 (i.e. overlay structure 1250) analogous to overlay structure 1050. Although a contiguous overlay structure 1250 is shown, in some embodiments, the overlay structure may have multiple separate pieces. Also shown are substrate structure 1202 that may be analogous to substrate structure 1002.

Waveguide 1210 includes slab 1212 and ridge 1214 that are analogous to slab 1012 and ridge 1014. Waveguide 1210 includes first portion 1211, transition portion 1213, and second portion 1213 that are analogous to first portion 1011, transition portion 1213, and second portion 1215. Overlay structure 1250 is analogous to overlay structure 1050 but has a different footprint. In the embodiment shown, overlay structure 1250 tapers after termination of ridge 1214. Other shapes are possible.

Overlay structure 1250 may function in an analogous manner to and provide benefits analogous to overlay structure 1050. Thus, photonics device 1200 may share the benefits of photonics device 1000. In particular, overlay structure 1250 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1250 may be more readily integrated into manufacturing of photonics device 1200. Thus, performance may be improved without unduly complicating manufacturing.

FIG. 13 depicts a plan view of an embodiment of a portion of photonics device 1300 having a mode transition. Photonics device 1300 includes waveguide 1310 having first portion 1311, transition portion 1313, and second portion 1315 that are analogous to waveguide 1010, first portion 1011, transition portion 1013, and second portion 1015. Similarly, photonics device 1300 includes index smoothing structure 1350 (i.e. overlay structure 1350) analogous to overlay structure 1050. Although a contiguous overlay structure 1350 is shown, in some embodiments, the overlay structure may have multiple separate pieces. Also shown are substrate structure 1302 that may be analogous to substrate structure 1002.

Waveguide 1310 includes slab 1312 and ridge 1314 that are analogous to slab 1012 and ridge 1014. Waveguide 1310 includes first portion 1311, transition portion 1313, and second portion 1313 that are analogous to first portion 1011, transition portion 1313, and second portion 1315. Overlay structure 1350 is analogous to overlay structure 1050 but has a different footprint. In the embodiment shown, overlay structure 1350 tapers asymmetrically. Other shapes are possible.

Overlay structure 1350 may function in an analogous manner to and provide benefits analogous to overlay structure 1050. Thus, photonics device 1300 may share the benefits of photonics device 1000. In particular, overlay structure 1350 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1350 may be more readily integrated into manufacturing of photonics device 1300. Thus, performance may be improved without unduly complicating manufacturing.

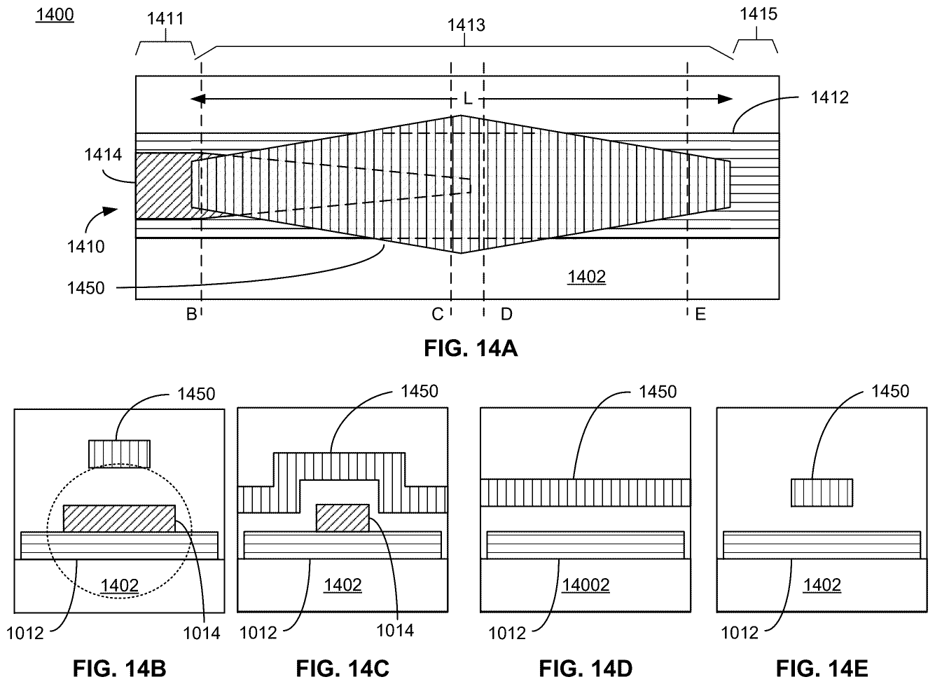

FIGS. 14A-14E depict an embodiment of a portion of photonics device 1400 having a mode transition. FIG. 14A depicts a plan view of photonics device 1400. FIG. 14B depicts a cross-sectional view of photonics device 1400 along dashed line B. FIG. 14C depicts a cross-sectional view of photonics device 1400 along dashed line C. FIG. 14D depicts a cross-sectional view of photonics device 1400 along dashed line D. FIG. 14E depicts a cross-sectional view of photonics device 1400 along dashed line E.

Photonics device 1400 includes waveguide 1410 having first portion 1411, transition portion 1413, and second portion 1415 that are analogous to waveguide 1010, first portion 1011, transition portion 1013, and second portion 1015. Similarly, photonics device 1400 includes index smoothing structure 1450 (i.e. overlay structure 1450) analogous to overlay structure 1050. Although a contiguous overlay structure 1450 is shown, in some embodiments, the overlay structure may have multiple separate pieces. Also shown are substrate structure 1402 and cladding 1060 that may be analogous to substrate structure 1002 and cladding 1060.

Waveguide 1410 includes slab 1412 and ridge 1414 that are analogous to slab 1012 and ridge 1014. Waveguide 1410 includes first portion 1411, transition portion 1413, and second portion 1413 that are analogous to first portion 1011, transition portion 1413, and second portion 1415. Overlay structure 1450 is analogous to overlay structure 1050, but is conformal to waveguide 1410.

Overlay structure 1450 may function in an analogous manner to and provide benefits analogous to overlay structure 1050. Thus, photonics device 1400 may share the benefits of photonics device 1000. In particular, overlay structure 1450 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1450 may be more readily integrated into manufacturing of photonics device 1400. Thus, performance may be improved without unduly complicating manufacturing.

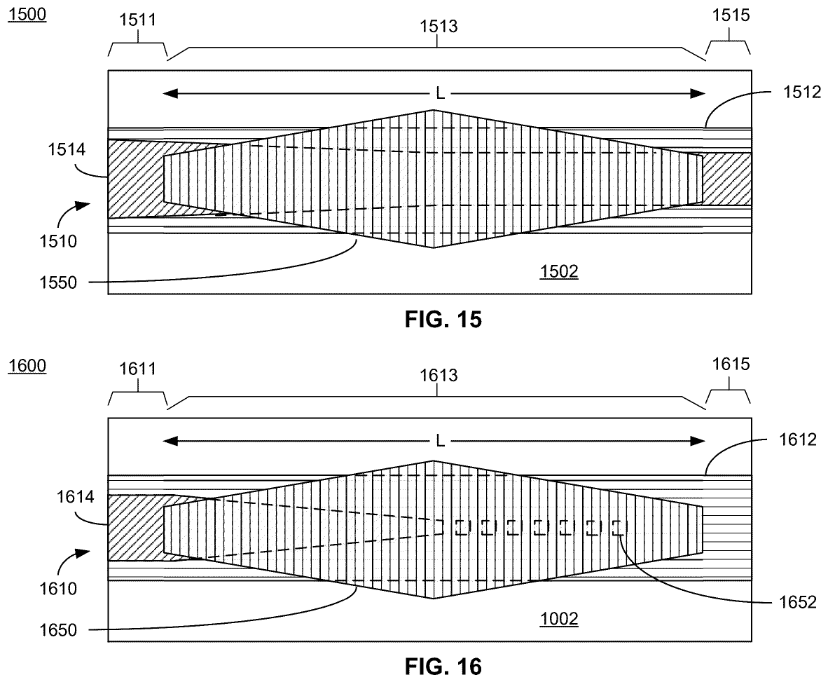

FIG. 15 depicts a plan view of an embodiment of a portion of photonics device 1500 having a mode transition. Photonics device 1500 includes waveguide 1510 having first portion 1511, transition portion 1513, and second portion 1515 that are analogous to waveguide 1010, first portion 1011, transition portion 1013, and second portion 1015. Similarly, photonics device 1500 includes index smoothing structure 1550 (i.e. overlay structure 1550) analogous to overlay structure 1050. Although a contiguous overlay structure 1550 is shown, in some embodiments, the overlay structure may have multiple separate pieces. Also shown are substrate structure 1502 that may be analogous to substrate structure 1002.

Waveguide 1510 includes slab 1512 and ridge 1514 that are analogous to slab 1012 and ridge 1014. Waveguide 1510 includes first portion 1511, transition portion 1513, and second portion 1513 that are analogous to first portion 1011, transition portion 1513, and second portion 1515. However, ridge 1514 does not terminate. Instead, ridge 1514 simply tapers. Other and/or additional changes to ridge 1514 and/or slab 1512 may be made. Overlay structure 1550 is analogous to overlay structure 1050.

Overlay structure 1550 may function in an analogous manner to and provide benefits analogous to overlay structure 1050. Thus, photonics device 1500 may share the benefits of photonics device 1000. In particular, overlay structure 1550 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1550 may be more readily integrated into manufacturing of photonics device 1500. Thus, performance may be improved without unduly complicating manufacturing.

FIG. 16 depicts a plan view of an embodiment of a portion of photonics device 1600 having a mode transition. Photonics device 1600 includes waveguide 1610 having first portion 1611, transition portion 1613, and second portion 1615 that are analogous to waveguide 1010, first portion 1011, transition portion 1013, and second portion 1015. Similarly, photonics device 1600 includes overlay structure 1650 analogous to overlay structure 1050. Although a contiguous overlay structure 1650 is shown, in some embodiments, the overlay structure may have multiple separate pieces. Also shown are substrate structure 1602 that may be analogous to substrate structure 1002.

Waveguide 1610 includes slab 1612 and ridge 1614 that are analogous to slab 1012 and ridge 1014. Waveguide 1610 includes first portion 1611, transition portion 1613, and second portion 1613 that are analogous to first portion 1011, transition portion 1613, and second portion 1615. Overlay structure 1650 is analogous to overlay structure 1050. However, an additional portion of an index smoothing structure is provided. In particular, sub-wavelength features 1652 are also present. Thus, multiple types of index smoothing structures may be employed in photonics devices.

Overlay structure 1650 may function in an analogous manner to and provide benefits analogous to overlay structure 1050. Sub-wavelength features 1652 may function in an analogous manner to and provide the benefits of sub-wavelength features 252. Thus, photonics device 1600 may share the benefits of photonics device 1000. In particular, overlay structure 1650 may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure 1650 may be more readily integrated into manufacturing of photonics device 1600. Thus, performance may be improved without unduly complicating manufacturing.

FIGS. 2A-16 depict embodiments of portions of photonic devices including various index smoothing structures and waveguide configurations. Although particular aspects of the index smoothing structures and waveguides are described and highlighted in FIGS. 2A-16, the features described may be combined in manners not explicitly depicted. For example, the pitch, size, number, and/or shape of the sub-wavelength features may vary in a different manner. Although particular shapes/tapers are shown for the additional material and waveguide portions, other shapes may be used. For example, instead of a diamond shaped inverse taper and taper for the additional material, curved tapers, reverse tapers, rectangles, and/or other shapes may be used. In the embodiment shown, different fill indicates different materials and/or layers. In another example, in FIG. 16, sub-wavelength features 1652 having a particular pitch are combined with overlay structure 1650 having a particular shape and location. In some embodiments, sub-wavelength features (e.g. sub-wavelength features having a different pitch may be combined with an overlay structure having a different shape and/or location. Thus, the embodiments described herein are for explanation and not intended to be limiting. Further, FIGS. 2A-16 are not to scale.

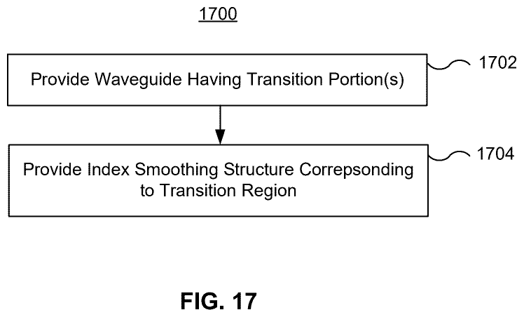

FIG. 17 is a flow chart depicting an embodiment of method 1700 for providing a photonics device. Other and/or additional processes may be used. Further, one or more steps of method 1700 may include multiple substeps. Method 1700 is also described in the context of forming a single photonics device. However, multiple devices may be formed in parallel. Method 1700 is also described in the context of photonics devices 200 and 1000. Method 1700 may be used in fabricating other electro-optic devices, such as devices 100, 300, 400, 500, 600, 700, 800, 900, 1100, 1200, 1300, 1400, 1500, and/or 1600.

The waveguide(s) are provided, at 1702. Thus, any ridge(s), slabs, and/or other features of the waveguide are provided. In addition, 1702 includes forming transition portion(s) of the waveguide. Thus, the waveguide formed at 1702 converts between optical modes.

One or more index smoothing structures are provided, at 1704. For example 1704 may include defining sub-wavelength features during (or at another time than) formation of the waveguide. In some embodiments, formation of the sub-wavelength features at 1704 may take place along with the formation of the waveguide(s) at 1702. In some embodiments, 1704 includes forming an overlay structure. Thus, additional deposition, lithography (e.g. photolithography), etching, and/or other processing steps may be performed.

For example, waveguide 210 may be provided at 1702. Thus, TFEO materials may be etched to form ridge 214 and slab 212. Index smoothing structure 250 is provided at 1704. In some embodiments, 1704 includes forming sub-wavelength features 252 along with ridge 214 and/or slab 212. Thus, photonics device 200 may be provided. In another example, waveguide 1010 may be provided at 1702. Fabrication may continue. For example, at least some of cladding 1060 may be formed. In addition, overlay structure 1050 is provided at 1704. Thus, photonics device 1000 may be provided. In another example, waveguide 1610 may be provided at 1702. At 1704, sub-wavelength features 1602 may be formed. This portion of 1704 may be performed as part of 1702, in conjunction with formation of waveguide 1610. In addition, fabrication may continue. For example, at least some of cladding 1660 may be formed. In addition, overlay structure 1650 is also provided at 1704. Thus, photonics device 1600 may be fabricated.

Thus, using method 1700, the benefits of the photonics devices described herein may be achieved. In particular, index smoothing structure(s) may allow for a more gradual change in the effective index of refraction, reduced losses, reduced polarization dependent losses, and/or improved mode matching. Further, with judicious selection of the materials used consistent with TFLCEO and/or CMOS processing (e.g. silicon oxynitride), formation overlay structure(s) may be more readily integrated into manufacturing of photonics device. Thus, performance may be improved without unduly complicating manufacturing.

Although the foregoing embodiments have been described in some detail for purposes of clarity of understanding, the invention is not limited to the details provided. There are many alternative ways of implementing the invention. The disclosed embodiments are illustrative and not restrictive.

1. A photonics device, comprising:
a waveguide configured to carry an optical signal and including a thin film lithium-containing electro-optic (TFLCEO) material, the waveguide having a first portion, a transition portion, and a second portion, the optical signal having a first mode in the first portion and a second mode in the second portion, the transition portion transferring the optical signal between the first portion and the second portion and transitioning between the first mode and the second mode; and
an index smoothing structure corresponding to the transition portion, the index smoothing structure configured to transition a first effective index of refraction for the first mode to a second effective index of refraction for the second mode, the index smoothing structure having an intermediate effective index of refraction.

2. The photonics device of claim 1, wherein the index smoothing structure includes at least one of at least one sub-wavelength feature and an overlay structure, the at least one sub-wavelength feature having a dimension less than a wavelength of the optical signal.

3. The photonics device of claim 2, wherein the dimension of the at least one sub-wavelength feature is not more than ¼ of the wavelength of the optical signal.

4. The photonics device of claim 2, wherein the at least one sub-wavelength feature includes a plurality of sub-wavelength features having a pitch and at least one size.

5. The photonics device of claim 4, wherein the pitch varies.

6. The photonics device of claim 4, wherein the pitch is constant.

7. The photonics device of claim 4, wherein dimension varies.

8. The photonics device of claim 2, further comprising:
an optical material adjacent to the waveguide and having an index of refraction; and
wherein the overlay structure has an overlay index of refraction greater than the index of refraction.

9. The photonics device of claim 8, wherein the overlay structure intersects a transition optical mode of the optical signal for the transition portion.

10. The photonics device of claim 8, wherein the overlay structure is not more than one micrometer from the waveguide.

11. The photonics device of claim 8, wherein the overlay structure shares an interface with the waveguide.

12. The photonics device of claim 8, wherein the overlay structure includes at least one of silicon nitride, silicon, lithium niobate, silicon oxide nitride, doped silicon, aluminum nitride, or titanium doped silicon dioxide.

13. The photonics device of claim 8, wherein the index smoothing structure is configured such that a transition portion optical mode has at least an eighty percent match with the first mode and with the second mode.

14. The photonics device of claim 13, wherein the transition portion optical mode has at least a ninety percent match with the first mode and with the second mode.

15. The photonics device of claim 1, wherein the index smoothing structure is configured such that optical losses through the transition portion do not exceed 0.5 dB.

16. A photonics device, comprising:
a waveguide configured to carry an optical signal and including a thin film lithium-containing electro-optic (TFLCEO) material, the waveguide having a first portion, a transition portion, and a second portion, the optical signal having a first mode in the first portion and a second mode in the second portion, the transition portion transferring the optical signal between the first portion and the second portion and transitioning between the first mode and the second mode; and
an index smoothing structure corresponding to the transition portion, the index smoothing structure configured to transition a first effective index of refraction for the first mode to a second effective index of refraction for the second mode, the index smoothing structure having an intermediate effective index of refraction, the index smoothing structure includes at least one of a plurality of sub-wavelength features and an overlay structure, each of the plurality of sub-wavelength feature having a dimension less than one-fourth of a wavelength of the optical signal, the plurality of sub-wavelength features extending a distance equal to at least three multiplied by the wavelength, the overlay structure having an overlay index of refraction greater than an index of refraction of an optical material adjacent to the waveguide.

17. A method, comprising:
providing a waveguide configured to carry an optical signal and including a thin film lithium-containing electro-optic (TFLCEO) material, the waveguide having a first portion, a transition portion, and a second portion, the optical signal having a first mode in the first portion and a second mode in the second portion, the transition portion transferring the optical signal between the first portion and the second portion and transitioning between the first mode and the second mode; and
providing an index smoothing structure corresponding to the transition portion, the index smoothing structure configured to transition a first effective index of refraction for the first mode to a second effective index of refraction for the second mode, the index smoothing structure having an intermediate effective index of refraction.

18. The method of claim 17, wherein the providing the index smoothing structure further includes:
providing at least one of a plurality of one sub-wavelength features and at least one overlay structure, each of the plurality of sub-wavelength features having a dimension less than a wavelength of the optical signal, the at least one overlay structure having an overlay index of refraction greater than an index of refraction of an optical material adjacent to the waveguide.

19. The method of claim 18, wherein the dimension is not more than ¼ of the wavelength of the optical signal.

20. The method of claim 18, wherein the overlay structure is configured such that a transition portion optical mode has at least an eighty percent match with the first mode and with the second mode.
